(19) United States
(12) Patent Application Publication
(10) Pub. No.: US 2008/0260915 A1
(43) Pub. Date: Oct. 23, 2008

(54) Method and apparatus for producing dry food supplements from fruits, vegetables, and other sources

(76) Inventor: Ahmad Alkayali, Lake Forest, CA (US)

Correspondence Address: Law Office of Terry L. Miller, 24832 Via San Fernando, Mission Viejo, CA, 92692, US

(21) Appl. No.: 11/787,512

(22) Filed: Apr. 17, 2007

(51) Int. Cl. A23L 1/212

(52) U.S. Cl. 426/96

(57) ABSTRACT

A method for producing a dry food supplement with a flaky, powdery, or granular consistency from a selected moist source material includes a step of providing the moist source or starting material. This starting material to be dried is suspended or floated on a heat-transfer film on the surface of a body of heated but not boiling water to absorb heat from the water. The film prohibits moisture transfer from the body of heated water to the material to be dried. The heat transfer causes drying of the material. An apparatus for carrying out the method includes a reservoir of water, a film buoyantly supported on the water, and a heater for maintaining the temperature of the water at a predetermined level. In a preferred embodiment, the reservoir is in the form of an elongated trough and the film forms a conveyor belt that floats on the surface of the water. Preferably, a humidity-controlled stream of drying air is also directed over the drying material, and the drying process is continued until a dry flake or mass is produced. This dry flake or mass may be generally flaky or can be powdered or granular, dependent upon the nature of the starting material and the consistency of the product desired.

### BACKGROUND OF THE INVENTION

1. Field of the Invention

This invention relates to food supplements, and particularly relates to dry powder, granular, or flake types of food supplements which are produced by drying fruits, vegetables, or other source materials, without the use of elevated temperatures. For example, the source materials may include red wine, red grapes, white grapes (especially the white muscadine grape, and especially the seeds of this grape), cherries, pomegranate, or animal tissues providing collagen protein. By avoiding the use of elevated temperatures, the food values and nutritional constituents of the fruits, vegetables, and other source materials are preserved and are not oxidized or deteriorated by excessively elevated temperatures.

2. Related Technology

Most processes for drying moist slurries, mixtures, and pastes of fruit pulp or vegetable pulp, for example, to produce fruit leathers or concentrates of the fruit or vegetable pulp involve placing the pulp on a carrier and then heating the carrier to dry the pulp. In these systems temperatures above boiling may be employed. In other such instances, a metallic carrier is provided on which the fruit or vegetable pulp is carried and is then heated by electrical induction. The heat is used to drive the moisture from the pulp, but temperature of the pulp is not closely controlled. Particularly, localized areas of the pulp may experience temperatures well above boiling, with concomitant deterioration of the food value and nutrients present in the pulp. Since the entire carrier is inductively heated, it is necessary to ensure that every portion of the carrier is covered with pulp in order to prevent edge portions of the pulp from being excessively dried and overly heated. In fact, it is difficult or impossible to obtain such complete coverage of the carrier with the fruit or vegetable pulp, and therefore heat is lost to the open air without doing any substantial work in drying the pulp, and edge portions of the pulp are overheated and deteriorated.

It is known to product fruit leathers (i.e., a “ribbon” of moist flexible fruit product) by drying a moist product, such as fruit pulp, that includes the steps of floating a film of transparent material on a body of water, heating the water to maintain the water at a predetermined temperature, and placing the product to be dried on the floating film. The fruit leather product contains a considerable quantity of moisture, and is not a dry product. See, U.S. Pat. No. 4,631,837, issued 30 Dec. 1986 to Magoon. However, the production of dry granular, flake, or powder products from fruits and vegetables, and the preservation of the food values and nutrients in the fruits and vegetables by the avoidance of elevated processing temperatures is not disclosed in the conventional technology.

Further to the above, it is known to produce dry collagen protein powder from the cartilage of chickens and other animals, in order to provide a collagen food supplement beneficial to humans and other animals. In many cases, these known methods of producing collagen food supplements from animal source materials involve extraction of the collagen by use of chemical or thermal processes. In some cases, the collagen material from the source is deteriorated or oxidized by the extraction methods.

### SUMMARY OF THE INVENTION

In view of the deficiencies of the conventional technology, an object for this invention is to overcome or ameliorate one or more of those deficiencies.

An additional object for this invention is to provide a dry product food supplement from moist fruit, vegetables, or other moist source materials that is made by drying a source material, for example, a moist pulp of the fruits or vegetables, without ever subjecting the source materials to a processing temperature above the boiling point of water.

The present invention provides a method for making or producing dry food supplements, and particularly for making dry powder, granular, or flake types of food supplements which are produced by drying moist fruits, vegetables, or other moist source materials without the use of elevated temperatures.

The method of drying a moist source material product, such as moist fruit pulp, or moist vegetable pulp, or other moist source material includes the steps of floating a film of water-impermeable, heat-transfer material on a body of heated water, maintaining the temperature of the water at a controlled elevated temperature sufficiently low that boiling is avoided, placing the product to be dried on the floating film, transferring heat from the water to the source or starting material while preventing flow of water from the body of water to the source material, directing a drying stream of air over the product pulp, and continuing the process until the product pulp has been reduced in moisture content to the extent that a substantially dry product or mass is produced. This dry product or mass is most usually in the form of a dry flake material or dry powder.

In preferred forms of the invention the floating material can be a flexible plastic and can be arranged on a conveyor system so that it moves across a reservoir of heated water carrying the pulp or other source material from a loading station to a removal station with the timing of the conveyor belt and the parameters of the product being applied to the conveyor belt being such that the product is applied in a suspension of solid particles in a liquid base (i.e., as a slurry, mash, suspension, or paste, for example) at one end of the conveyor and with the dried product being removed in its dried state at the second end of the conveyor. While certain preferred materials are known for use as the floating carrier film, it is sufficient if the carrier is transparent to infrared radiation (e.g., has a favorable heat transfer), is substantially impermeable to water, and is able to withstand temperatures in the range of the boiling point of water without shrinkage or deterioration of the material.

Most preferably, the source material is dried at a controlled low temperature, while being exposed to a selectively controlled humidity, and also while being protected from exposure to ultraviolet light.

The operation and advantages of the present invention will be better understood by those of ordinary skill in the art and others upon reading the ensuing specification when taken in conjunction with the appended drawings wherein:

### BRIEF DESCRIPTION OF THE DRAWING FIGURES

FIG. 1 is a side elevation view of a particularly preferred embodiment of a fruit pulp drying machine in accord with the present invention;

FIG. 2 is a perspective elevation end view of the drying machine seen in FIG. 1; and

FIG. 3 is a sequential list of method steps utilized in the method of producing a dry food supplement from moist fruits or moist vegetables or other moist source materials according to the present invention.

### DETAILED DESCRIPTION OF THE PREFERRED EMBODIMENTS

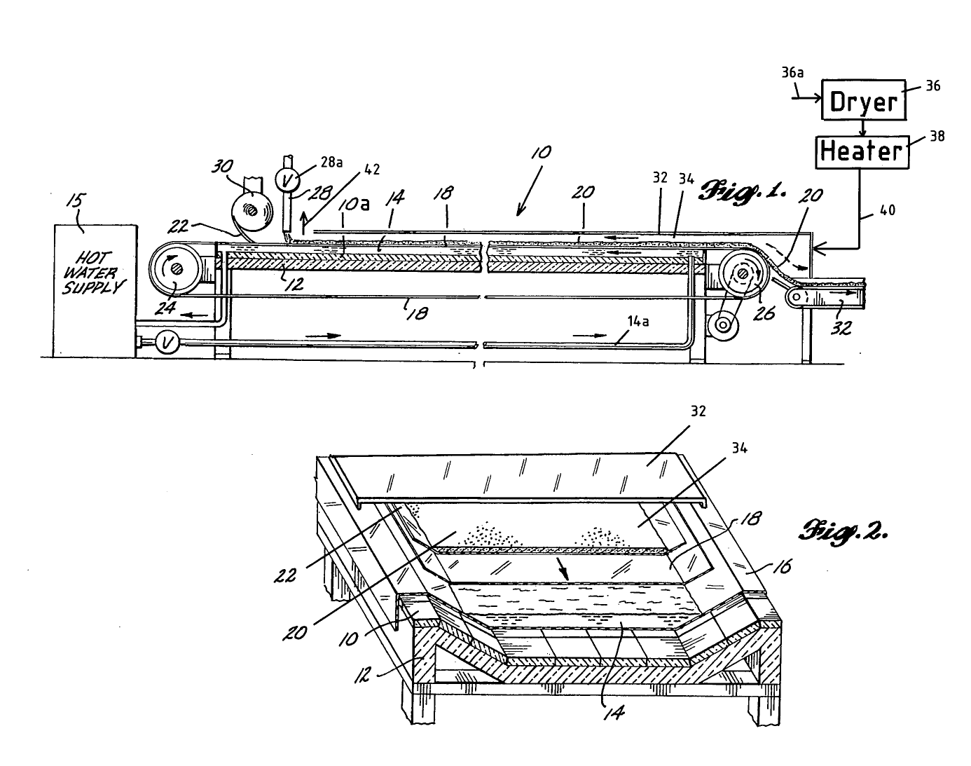

Viewing FIGS. 1, 2, and 3 in conjunction with one another, it is seen that a machine 10 for the continuous production of a dry food supplement from moist fruit pulp, or moist vegetable pulp, or other moist source material according to this invention is formed somewhat as an elongate trough 10a. The trough 10a is formed of some nonporous medium, such as ceramic tile or sheet metal carried on a supporting and generally insulating substrate or base 12. Heated and counter-flowing water, heated to a temperature close to (but less than) boiling, is provided at the right end of the trough 10a (as seen in the drawing FIG. 1) via a pipeline 14a. This heated water 14 is pumped into the trough 10a from a source 15 of heated water, which may include an electric water heater, or a water heater fueled by any suitable fuel source, such as natural gas, wood, coal, etc. In practice, the heated water flows into the trough 10a at a first end which is at the right-hand end of the trough 10a as seen in drawing FIG. 1, and the trough is preferably slightly tilted along its length to be higher at the right-hand end so that the heated water (as it loses heat to the drying fruit pulp, or vegetable pulp, or other source material, as will be further explained) runs by the force of gravity (see the water flow arrow on FIG. 1) to a second end of the trough 10a, which is the left-hand end as illustrated. From the left-hand end of the trough 10a, the now-cooler water is pumped back to the water heater 15, and is there reheated to the desired temperature. Thus, the water is re-used or is re-circulated, is re-heated, and it then pumped once again back into the trough 10a at the right-hand end so that the water in the trough is always maintained close to the predetermined, desired temperature. As will be further explained, however, the water flow is counter to the movement of fruit pulp, or vegetable pulp, or other source material along the trough 10a, so that the highest temperature water is exposed to the nearly dried pulp, and the cooler water (i.e., cooled by passage along the length of trough 10a) is used to warm the initially room-temperature pulp at this pulp is delivered onto the trough 10a.

In the illustrated embodiment, a sheet 16, which may preferably be made of polyethylene sheet material, lines the inner surface of the trough 10 and overhangs the edges of the trough to provide an additional moisture and heat barrier between the water and the trough. A flexible sheet of infrared-transparent, and substantially water-impermeable material 18 floats on the surface of the water 14 in the trough 10a. A suitable material has been found to be 300A Mylar, most preferably in a 3-mil-thick sheet. This 300A Mylar material is available from E. I. Dupont De Nemours Co. The 300A Mylar meets all of the requirements of the invention in that it shows very little distortion or shrinkage in the operable temperature range utilized in the machine 10. Further, this 300A material is flexible so that it lends itself to a conveyor belt type of application and also has the strength required to operate for long periods of time without breakage. While the polyester sheet 18 only needs to float on top of the water in the illustrated embodiment, the polyester sheet is wider than the trough 10 so that it not only overlies the water but also rides slightly up the sides of the trough 10a. The extra width of the polyester sheet 18 ensures a complete coverage of the water so that there is no evaporative exposure of the water to the open air above the trough. The overly-wide sheet 18 also provides a channel that keeps the product to be dried 20, which typically is a moist fruit pulp or moist vegetable pulp, or other moist source material in the form of a mixture, mash, past, slurry, or puree consisting of solid particles in suspension in a fruit or vegetable juice, from running off of the polyester sheet into the hot water.

The moist source material to be dried, for example, fruit pulp 20, is placed in a thin layer on top of the polyester sheet 18 and remains on the polyester sheet until it reaches the proper consistency or dryness, that is, until a predetermined amount of the moisture is driven off the mixture by the heat transferred from the hot water to the fruit pulp through the polyester sheet. It has been found that a thickness of approximately one-eighth to three-sixteenths of an inch for the layer 20 of material to be dried is capable of producing a satisfactory dried flake or mass of product. In the illustrated embodiment, a thin sheet 22 of material such as polyethylene, for example, 0.5 to 1.5 mils thick, is placed between the polyester sheet 18 and the fruit pulp 20. The polyethylene sheet 22 does not enter directly into the workings of the process of the present invention, but, rather, supplies a convenient medium upon which to place the fruit pulp or other moist source material to prevent adherence of the pulp to the polyester sheet 18. The polyethylene sheet 22 is removed from the polyester sheet 18 with the dried fruit or vegetable pulp to maintain the polyester sheet 18 in a clean condition for further processing and in suitable for use as a food supplement. Also, the polyethylene sheet separates easily from the Mylar sheet 18 so that the Mylar sheet is not damaged as it might be if it was necessary to scrape the dried fruit or vegetable pulp directly off of the polyester sheet. The polyethylene sheet 22 and dried flake product can be removed simultaneously from the polyester sheet to provide a convenient method by which the dried product is transported for further processing (i.e., flaking, powdering, or granulizing) and/or stored after its removal from the dryer.

In one preferred form of the invention, the polyester sheet 18 is formed in an endless belt and is carried by a pair of rollers 24 and 26, respectively, mounted at either end of the trough 10a to form a conveyor belt. The moist fruit pulp or vegetable pulp or other moist source material 20 to be dried is introduced onto the polyester sheet at a first end of the trough from a discharge pipe 28 via a valve 28a. Most preferably, the discharge pipe 28 terminates in a spreader nozzle (not shown in the drawing Figures) having a width sufficient to place a wide thin ribbon of the moist pulp on the sheet 22. The polyethylene sheet 22 is fed from a roll 30, also at the first end of the trough 10a, so that the pulp 20 lies on the polyethylene sheet 22. It is necessary to keep a slack in the polyester conveyor belt 18 so that the film floats on the water and is not under such tension that it resists contact with the water surface when the pulp is placed on the belt.

Subsequently, the pulp 20 moves over the counter-flowing hot water 14 on the polyester sheet conveyor belt 18 to the second end of the trough 10a. During this travel, the pulp 20 is warmed and gives up moisture. Conversely, the counter flowing water 14 is cooled. The speed of the conveyor belt is regulated so that the time that it takes for the fruit or vegetable pulp to travel from one end of the trough 10a to the other is sufficient to produce the proper drying of the pulp so that it can be removed along with the polyethylene sheet 22 at the second end of the trough 10a in the form of a dry flake or mass. Most preferably, the transit time for the pulp and the length of the trough 10a are selected such that a dry flake or mass is provided at the right-hand end of the trough 10a. The polyester belt 18 continues on to return to the left-hand end of the machine 10 under the trough 10a in a typical conveyor fashion, while the dried pulp is moved away on a second conveyor 32.

In one form of the invention, which has been tested, it has been found that a fruit pulp of one-eighth to three-sixteenths inch thickness placed on a Mylar sheet 3 mils thick over a trough of water in which the water depth is approximately one inch and the water is heated to just below the boiling point, that is, just below 100 degrees C., takes approximately at least two and one-half hours to dry to a suitable degree. Typically, the pulp 20 may be open to the air during its drying. It may be thought that it would not be desirable to direct any heated or dried air onto the pulp as it dries because this may form an undesirable skin on the top of the pulp and actually impede drying of the pulp by evaporation. This is the case unless the drying air flow stream is properly managed, as will be further explained. An air flow into and out of the room in which the dryer is located is certainly desirable to maintain the room air at a humidity that allows evaporation of the moisture in the pulp to the air and, in fact, dried heated air can be pumped into the room to lower the ambient humidity and increase the rate of absorption of water vapor by the air.

However, it has been found that in order to form a sufficiently dry flake type of product within a reasonable time interval and length for the trough 10a, that the pulp can be beneficially exposed to a dried and heated air flow, and especially to a confined counter-flow air flow. To this end, a cover 32 may be provided over substantially all of the length of the trough 10a, defining a captive air space 34 which opens to ambient at the left-hand end of the trough 10a, as will be further explained. A dryer 36 receives ambient air 36a, and dries this air (i.e., by desiccant or refrigeration process, for example). The dried air is then supplied to a heater 38 which heats the dry air to a controlled selected temperature well above ambient, and possibly close to but less than boiling point of water, and supplies this dried and heated air via duct 40 into the right hand end of the trough 10a in air space 34. Because of the counter flow of the dried and heated air relative to the motion of the pulp 20 (see the air flow arrow on FIG. 1), the tendency to form an undesirable dry crust on the surface of the product is reduced because the product pulp is first exposed (i.e., near the left-hand end of trough 10a) to a warm but humid drying air flow. This air flow has gained substantial humidity by passing along the length of trough 10a over the drying pulp product. So, drying of the pulp product at the left-hand end of the trough 10a is effected by a combination of warm water heating, and heating by warm air that is relatively high in humidity. On the other hand, as the drying product pulp progresses toward the right (viewing FIG. 1) and approaches the right-hand end of the trough 10a, drying is effected by the warmest water in trough 10a in combination with the warmest and driest air in air space 34. Thus, a dry flake product is produced at the right-hand end of trough 10a, and is delivered onto conveyor 32, ready for further processing (such as placement in capsules or in bottles, for example).

Further to the above, it will be appreciated that the cover 32 is effective to shield the drying product below this cover from ultraviolet (UV) light. Such UV light could undesirably deteriorate or degrade some constituents of some food supplement products being processed according to this invention. Further, once the dried flake or mass food supplement product is provided by the process at the right-hand end of machine 10 onto conveyor 32, efforts are preferably made to also protect the dried food supplement product from exposure to UV light until the product is packaged in UV resistant packaging (i.e., in UV resistant bottles, for example).

In an apparatus described above with a water depth of at least one inch in the trough 10a, and with a trough of at least 12 meters in length, it has been found that the temperature drop of the water from the inlet at one end of the trough to the outlet from the trough is about 3 degrees C., or more. Therefore, the hot water source 15 does not have to expend much energy in raising the temperature of the water back to the desired temperature prior to reintroduction of the water into the trough 10a. The counter-flowing heated and dried air in air space 34, on the other hand, exits the machine 10 at 42 (see the air flow arrow on FIG. 1), and is now less warm but very moist (i.e., high in humidity) and is preferably captured by a vent hood (not seen in the drawing Figures) carrying this air of very high humidity outside of the processing environment.

It is important that the temperature of the fruit, or vegetable, or other product mixture 20 be kept below the boiling point so that there is no disruption or deterioration of the drying source material on the polyester sheet 18. And, this temperature restriction is very important for preservation of the natural nutrient values of the product. Typically, the fruit pulp or vegetable pulp or other drying source material is kept at a temperature of between 70 and 90 degrees C. Also, the water temperature, of course, should be kept below boiling in order to prevent bubbling and rapid evaporation of the water from the trough. The temperature of the heated and dried air introduced via duct 40 is also most preferably kept below the boiling point for water.

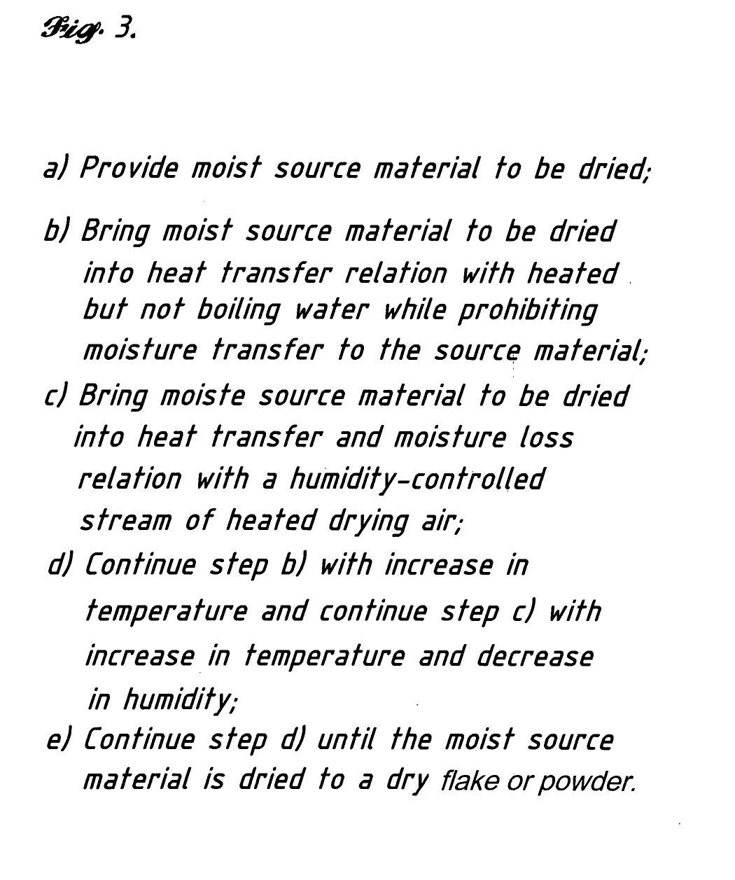

Having observed the details of the machine 10 and its operation, attention may now be directed to FIG. 3, and the method of the present invention. As will be recalled, in accordance with the present method, a reservoir of water, such as in a trough, is heated to some predetermined temperature close to be preferably below the boiling point of water. A thin film of transparent material (i.e., transparent to heat or IR radiation), such as a polyester film, is floated on the water surface in the trough so that it covers substantially the entire open surface area of the water. Because of the floating contact of the film on the water surface and the film covering the water, there is little, if any, evaporation from the water to the air above it. Then, a moist product to be dried, such as a puree of fruit pulp or vegetable pulp or other moist source material, is placed on the film in heat-transfer contact with the surface of the water. The contact between the film carrying the product to be dried and the surface of the water enables a transfer of heat directly from the water through the film into the product to be dried causes the moisture in the product to be driven off. Additionally, a counter flow of dry, heated air may be effected above the product to be dried, assisting in producing a dry flake product. After the product to be dried is dried to a consistency of a dry flake or mass, this product is then packaged in convenient forms for use as a food supplement. For example, the dry product may be placed in capsules, may be pressed into pill form, or may be placed loose in bottles.

Giving attention to FIG. 3, it is seen that at step a) a moist pulp of fruit or vegetable product or other moist source material to be dried is provided. This product to be dried may be a red wine mixture (i.e., a slurry including red wine and rice powder for example), cherry pulp, tart cherry pulp, pomegranate pulp, grape pulp, white grape pulp (especially a pulp of the white muscadine grape, and especially the seeds of this grape), apricot pulp, or a pulp or moist slurry of any fruit or combination of fruits, including fruit juices. On the other hand, the product to be dried may include a vegetable pulp or slurry, such as carrot, potato, or green beans. The pulp product may include the whole fruit or vegetable, or just the meat or seeds or skin, or the juice or juices of one or a selected combination of fruits or vegetables, or any combination of desired fruit or vegetable parts or portions, including plant roots for example. On the other hand, the moist source material may include, for example, a moist slurry of cleaned chicken sternal cartilage, which has been cleaned, chopped or ground to a fine consistency, and is carried in a paste, mash, or slurry of sufficient moisture for processing as described above to a dry flake consistency. Also, additional moisture may be added to the moist source material in the form of water, sucrose, or syrup, for example.

At step b) it is seen that the moist pulp product is brought into heat-transfer relation (but not moisture-transfer relationship) with a heated water bath having a temperature close to but less than the boiling point for water.

At step c) it is seen that simultaneously with step b) or at about the same time, the pulp product to be dried is brought into heat-transfer and moisture-loss relationship with a warm but humid air flow stream having a temperature also less than the boiling point of water so that moisture from the pulp product is lost to the air flow stream.

At step d) it is seen that step b) is continued possibly with a progressive slight increase in temperature (but still below the boiling point for water), while step c) is also continued with the temperature of the air flow stream increasing (but remaining below boiling) while the humidity becomes progressively dryer.

Step e) indicates that step d) is continued until the moist pulp product to be dried becomes a dry flake or mass.

After the source material is dried to a consistency of a dry flaked or mass, it may be packaged in convenient forms and quantities for use as a food supplement. Importantly, because the product is never exposed to a processing temperature above that of boiling water, deterioration or important food values and nutrients in the fruit or vegetable pulp does not occur. That is, the processing temperature is never made high enough to effect substantial oxidation or chemical alteration of the food nutrients in the starting material. In the case of processing chicken sternal cartilage to produce a flake collagen product, the processing is carried out at a controlled low temperature such that the collagen protein does not react with water in the source material to product a hydrolyzed collagen product, and is subsequently desiccated by the drying process, as described above. Additionally, by greatly reducing the mass (i.e., the moisture content) of the fruit or vegetable pulp product source or starting material, the resulting food supplement may be consumed in a much smaller quantity to obtain the benefits of the fruits or vegetables than would be required if a person were to eat the equivalent amount of raw or cooked fruit or vegetables. As an example of how much the drying process of the present invention results in a concentration of food values, tests have shown, for example, that a dry product made with red grape wine including 25 percent rice powder for consistency included 99.6 mcg/100 g of a particular food supplement chemical, while the moist starting material (i.e., before being processed to a dry flake consistency as described) included only 15.8 mcg/100 g of the same food supplement chemical. Another test sample of the same starting or source material dried to a flake consistency according to this disclosure resulted in a finding of 1.2 percent polyphenols (as gallic acid monohydrate), and 2 PVU of proanthocyanidins.

It will be understood that while one application of the invention described herein is in the production of a dry flake or mass from a source material, such as a puree of fruit pulp and juice, or wine, or from vegetable pulp and juice, or from chicken sternal cartilage, for example, the invention is not limited to the use with such fruit pulps. It also can be used for drying fruits, or vegetables, or even soups or stews that have been blended to an even consistency prior to drying. Further, the present invention can be used to produce a dry flake product of animal collagen. One example of this product which has been produced by the applicant was made by drying a moist paste of cleaned chicken sternal cartilage which had been finely ground with sufficient moisture to produce the paste. When dried as described above, the dry flaky food product was determined by assay to include a high presence of natural collagen in a form easily assimilated by humans. Thus, the possibly beneficial results of ingestion by humans of such a collagen food supplement product should be apparent.

Further, experiments by the Applicant have shown that the chemical constituents which are believed to be beneficial to humans, and which are present in several plant products, including grapes, raspberries, mulberries, peanuts, berries of the Vaccinium species, including blueberries, bilberries, and cranberries, some pines such as Scots pine and eastern white pine, and the roots and stalks of giant knotweed and Japanese knotweed, as well as in the Peruvian legume, Cassia quinquangulata, from which the chemical was first isolated. This chemical is believed to have important health benefits, such as anti-cancer, antiviral, neuroprotective, anti-aging, anti-inflamatory, and life-prolonging effects. For example, fresh grape skin contains about 50 to 100 micrograms of beneficial chemical per gram. It has been found that a dry food supplement made by drying a moist source material originating from a source selected as outlined above retains a substantial content of the beneficial food values, and that because the mass or quantity of the food supplement (compared to its moist state) is substantially reduced, a consumer of the food supplement need not consume nearly as much of the food supplement as they would have to consume of the source material in order to obtain the desired benefits.

I claim:

1. A method of drying a moist source material, such as a moist paste or slurry of fruit pulp or vegetable pulp to the condition of a dry flake or mass while maintaining a temperature below the boiling point of water, said method comprising the steps of:
(a) positioning and buoyantly supporting a sheet of water-impermeable, heat-transfer material on a body of heated water having a temperature below boiling so that a lower surface of the sheet is in contact with the water;
(b) placing the moist fruit or vegetable product to be dried in heat transfer relation above the sheet;
(b) transferring heat from the water through the sheet to the moist product to drive off water from the product; and
(c) continuing drying of the product until it reaches the condition of a dry flake or mass.

2. The method of claim 1, further including the step of moving a stream of air having a controlled humidity and temperature over the upper surface of the moist product to be dried.

3. The method of claim 1, wherein said sheet is elongate and moves relative to said body of water from a first end of said elongate sheet where said moist product is received to a second end where said dry flake or mass of product is removed from said sheet, and said body of water is flowing from said second end toward said first end, whereby said moist product and said water counter flow relative to one another.

4. The method of claim 2, wherein said sheet is elongate and moves relative to said body of water from a first end of said elongate sheet where said moist product is received on said sheet to a second end where said dry flake or mass of product is removed from said sheet, and said stream of air is flowing from said second end toward said first end of said sheet, whereby said moist product and said stream of air counter flow relative to one another.

5. The method of claim 4, wherein said stream of air is dehumidified before being introduced to said moist product at said second end of said elongate sheet.

6. The method of claim 4, wherein said stream of air is dehumidified and heated to an elevated temperature less than boiling before being introduced to said moist product at said second end of said elongate sheet.

7. The method of claim 4, wherein a cover is provided and said cover extends over said elongate sheet and said moist product thereon substantially from said first end thereof to said second end thereof, and said cover is effective to separate said air stream from ambient air over substantially the length of said elongate sheet.

8. The method of claim 4, wherein said cover is effective to protect said moist product and said dry flake or mass from UV light.

9. Apparatus for drying a moist source material, such as a moist fruit pulp or moist vegetable pulp or other moist source material to the condition of a dry flake or mass, said apparatus comprising:
an elongate basin for holding water;
a water heater for supplying heated water no hotter than boiling into said elongate basin; and
an elongate sheet of water-impermeable, heat-transfer material buoyantly supported on heated water in said elongate basin, whereby said elongate sheet of material may receive moist source material to be dried;
said elongate sheet being arranged to travel along said elongate basin from a first end at which the moist product is received thereon to a second end at which said dry flake or mass is discharged from said sheet;
said water heater being connected to discharge heated water into said elongate basin substantially at said second end and to receive cooler water from said first end for re-heating;
whereby said moist product to be dried and said heated water counter-flow along the length of said elongate basin.

10. The apparatus of claim 9, wherein said sheet comprises a sheet of polyester material.

11. The apparatus of claim 9, wherein said sheet substantially covers the entire surface of said reservoir so as to retard evaporation from the surface of the water.

12. The apparatus of claim 9, wherein said heating means includes a water heater separate from said reservoir, said water being heated in said water heater, said reservoir including an inlet to receive heated water from said water heater and an outlet to discharge water back to said water heater for reheating.

13. The apparatus of claim 9, wherein said sheet, as it is supported on the surface of said water, is moved in relation to the surface of said water in said reservoir.

14. The apparatus of claim 13, wherein said sheet is in the form of an endless belt that forms a conveyor to carry the product over the reservoir of water.

15. The apparatus of claim 9, further including a separation means between said sheet and said material to be dried, said separation means comprising a second sheet of material which is transparent to heat energy.

16. The apparatus of claim 9, wherein said sheet comprises a web of pliant, impervious plastic material.

17. Method of providing heat transfer drying between a body of heated liquid and a moist source material to be dried, comprising the steps of:
(a) positioning a sheet of heat-transfer and water-impervious material on the surface of the heated liquid so that the sheet is supported by a buoyant force of the liquid;
(b) maintaining the temperature of the liquid at an elevated temperature below boiling;
c) placing the product on the sheet; and
(d) selectively carrying away moisture given up by the drying source material by maintaining an air flow of selected humidity over the drying source material.

18. A method of preparing from a moist source material, such as a moist fruit pulp or moist vegetable pulp, or other moist source material a dry food supplement having a consistency selected from the group consisting of: flake, powder, and granular; while exposing the moist source material to a temperature always less than boiling, said method comprising steps of:
a) providing a moist source material to be dried
b) while prohibiting moisture transfer to the moist source material, bringing the moist source material into heat-transfer relation with a heated water bath having a temperature close to but less than boiling;
c) bringing the moist source material into heat-transfer and moisture-loss relationship with a warm and humidity-controlled air flow stream having a temperature also less than boiling so that moisture from the moist source material is lost to the air flow stream;
d) continuing step b) while effecting a progressive increase in temperature of the water bath toward but less than boiling
e) continuing step c) while effecting an increase in temperature of the air stream while always keeping the air stream temperature below boiling and also while decreasing the humidity of the air stream;
f) continuing steps d) and e) until the moist material to be dried becomes a dry flake or mass.

19. The method of claim 18, further including the step reducing the dry flake or mass of dried source material to a consistency selected from the group consisting of: flakes, powder, and granular.

20. A dry flake food supplement product produced from a moist source material selected from the group consisting of: red wine, red grapes, white grapes, white muscadine grapes, seeds of white muscadine grapes, cherries, tart cherries, pomegranate, animal cartilage tissues, and chicken sternal cartilage, by the controlled drying of said moist source material at a controlled elevated temperature always less than the boiling temperature of water.

21. The dry flake food supplement product according to claim 20, wherein said controlled drying of said moist source material is accomplished by flowing the moist source material in one direction along an elongate trough while suspended on a heat transfer and moisture impermeable sheet, and flowing heating water in a counter flow direction along said elongate trough in heat transfer relation with a lower side of said sheet.

22. The dry flake food supplement product according to claim 20, wherein said controlled drying of said moist source material is accomplished by flowing drying air along said elevated trough above the moist source material in a counter flow direction in heat and moisture transfer relation therewith.

23. The dry flake food supplement product according to claim 20, wherein said moist source material is substantially shielded from UV light during drying.

24. The dry flake food supplement product according to claim 20, wherein said dry flake food supplement product is packaged in a form selected from the group consisting of: packaging in capsules, pressing into pill form, and bottling of the dry flake product.
